(19) United States
(12) Patent Application Publication
(10) Pub. No.: US 2022/0319415 A1
(43) Pub. Date: Oct. 6, 2022

(54) DISPLAY PANEL AND DISPLAY DEVICE

(71) Applicant: Wuhan China Star Optoelectronics Semiconductor Display Technology Co., Ltd., Wuhan, Hubei (CN)

(72) Inventors: Xuanyun WANG, Wuhan, Hubei (CN); Chao DAI, Wuhan, Hubei (CN)

(73) Assignee: Wuhan China Star Optoelectronics Semiconductor Display Technology Co., Ltd., Wuhan, Hubei (CN)

(21) Appl. No.: 17/263,568

(22) PCT Filed: Aug. 20, 2020
(86) PCT No.: PCT/CN2020/110168

§ 371 Date: Jan. 27, 2021

(30) Foreign Application Priority Data
Aug. 7, 2020 (CN) 202010789802.0

(51) Int. Cl. G09G 3/3233

(52) U.S. Cl. CPC G09G 3/3233; G09G 2320/0233; G09G 2300/0452; G09G 2300/0861; G09G 2300/0819; G09G 2300/0842; G09G 2310/0297; G09G 2300/0443

(57) ABSTRACT

A display panel and a display device are provided. The display panel includes a plurality of pixel units and a plurality of pixel drive circuits. Each of the pixel units includes a plurality of pixels. At least one of the pixel drive circuits includes two different types of transistors, and is configured to respond to a light-emitting control signal to simultaneously drive two adjacent sub-pixels in the same pixel or two adjacent sub-pixels in two adjacent pixels. Therefore, a display uniformity is increased, and a display quality of the display panel is improved.

### FIELD OF DISCLOSURE

The present disclosure relates to the field of display technologies, and in particular to a display panel and a display device.

### BACKGROUND

In existing display panels, a plurality of sub-pixels generally correspond to a plurality of pixel drive circuits. Each sub-pixel is individually driven by a corresponding pixel drive circuit to realize a light-emitting control of the pixels. In this way, there is a driving difference between each sub-pixel and another adjacent sub-pixel during display, which makes it difficult to achieve optimal display uniformity when the display panel requires high resolution, and therefore further improvement is needed.

### SUMMARY OF DISCLOSURE

Embodiment of the present disclosure provide a display panel and a display device, which can improve a display uniformity, thereby improving a display quality of the display panel.

An embodiment of the present disclosure provides a display panel, including a plurality of pixel units and a plurality of pixel drive circuits. Each of the pixel units includes a plurality of pixels. At least one of the pixel drive circuits includes two different types of transistors, and at least one of the pixel drive circuits is configured to respond to a light-emitting control signal to simultaneously drive two adjacent sub-pixels in the same pixel or two adjacent sub-pixels in two adjacent pixels.

The present disclosure also provides a display panel, including a plurality of pixels and a plurality of pixel drive circuits. The plurality of pixels include a first sub-pixel and a second sub-pixel adjacent to the first sub-pixel, the first sub-pixel includes a first light-emitting device, and the second sub-pixel includes a second light-emitting device. At least one of the pixel drive circuits includes two different types of transistors, the pixel drive circuits is configured to respond to a light-emitting control signal to simultaneously drive two adjacent sub-pixels in the same pixel or two adjacent sub-pixels in two adjacent pixels. One of the pixel drive circuits includes a first transistor and an eighth transistor. The first transistor is configured to provide a first drive current to drive the first sub-pixel or the second sub-pixel to emit light. The eighth transistor is configured to provide a second drive current to drive the first sub-pixel or the second sub-pixel to emit light.

The present disclosure also provides a display device including the above-mentioned display panel.

In comparison with the prior art, the embodiments of the present disclosure provide the display panel and display device, where the display panel includes the plurality of pixel units and the plurality of pixel drive circuits. Each of the pixel units includes the plurality of pixels. At least one of the pixel drive circuits includes two different types of transistors, and at least one of the pixel drive circuits is configured to respond to the light-emitting control signal to simultaneously drive two adjacent sub-pixels in the same pixel or two adjacent sub-pixels in two adjacent pixels. Therefore, a display uniformity is increased, and a display quality of the display panel is improved.

### BRIEF DESCRIPTION OF DRAWINGS

FIG. 1 is a schematic diagram of a display panel of an embodiment of the present disclosure.

FIG. 2A to FIG. 2G are schematic diagrams of pixels of embodiments of the present disclosure.

FIG. 3A is a schematic diagram showing an arrangement of pixel drive circuits of the embodiment of the present disclosure.

FIG. 3B is a schematic diagram of a pixel drive circuit of the embodiment of the present disclosure.

FIG. 3C and FIG. 3D are schematic diagrams of the pixel drive circuit of the embodiment of the present disclosure.

FIG. 3E is an operation sequence diagram of the pixel drive circuit of the embodiment of the present disclosure.

FIG. 4A and FIG. 4B are schematic diagrams of a pixel drive circuit of an embodiment of the present disclosure.

### DETAILED DESCRIPTION

In order to make the objectives, technical solutions, and effects of the present disclosure more clear and specific, the present disclosure is described in further detail below with reference to embodiments in accompanying with drawings. It should be understood that the specific embodiments described herein are merely for explaining the present disclosure and are not intended to limit the present disclosure.

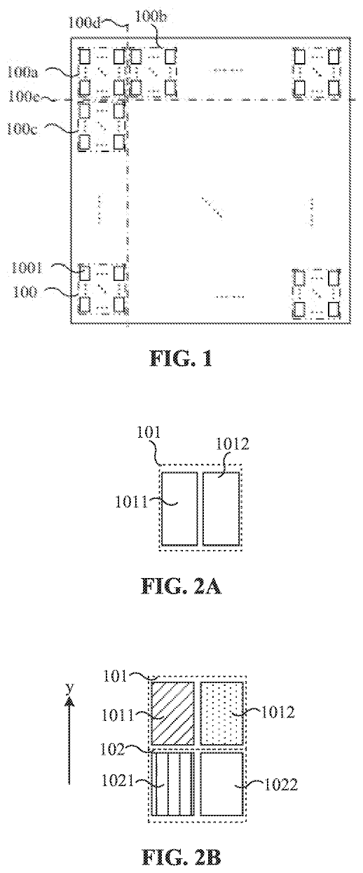

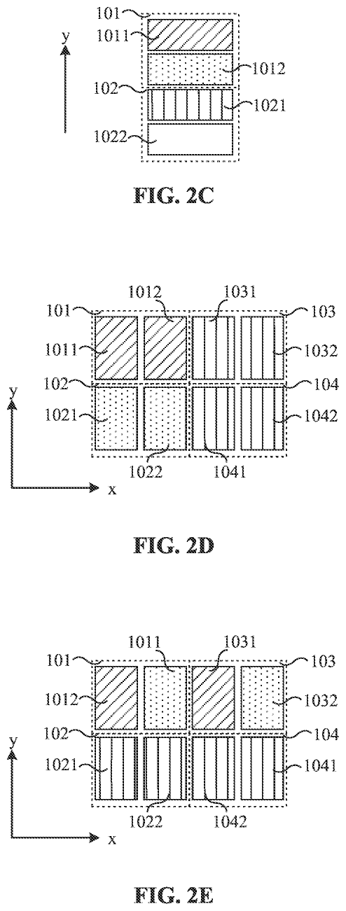

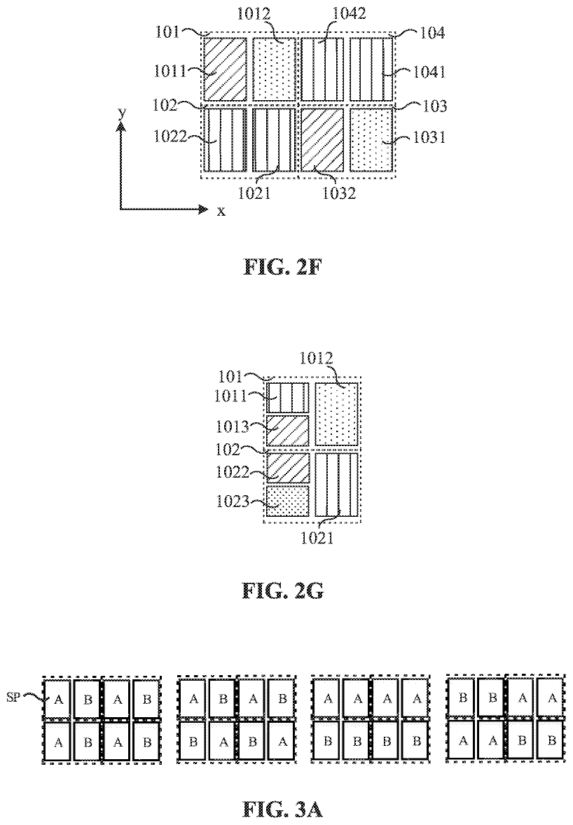

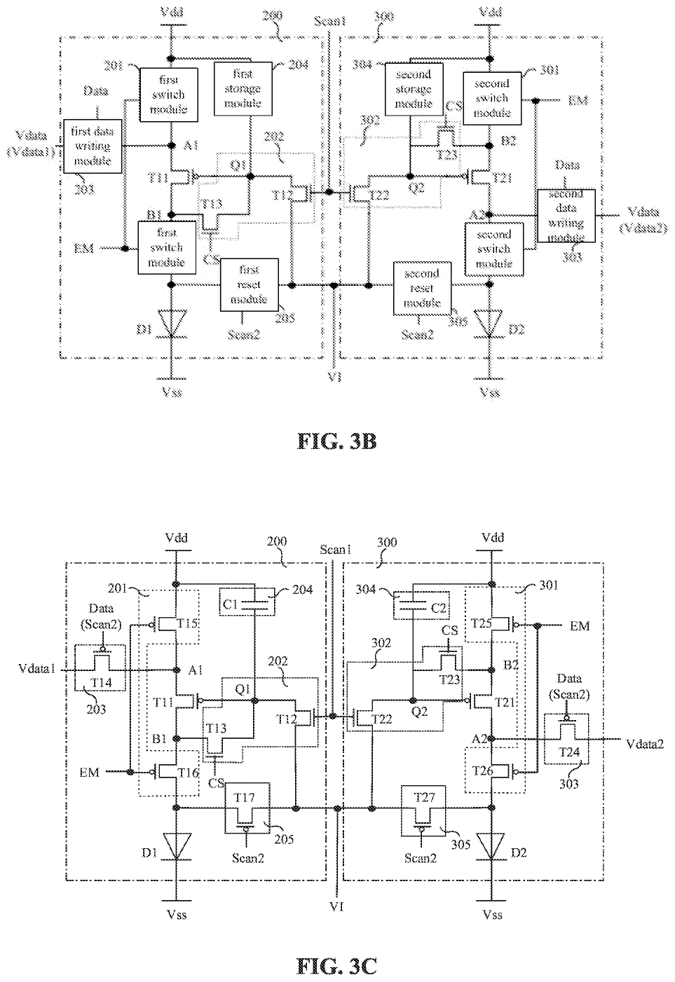

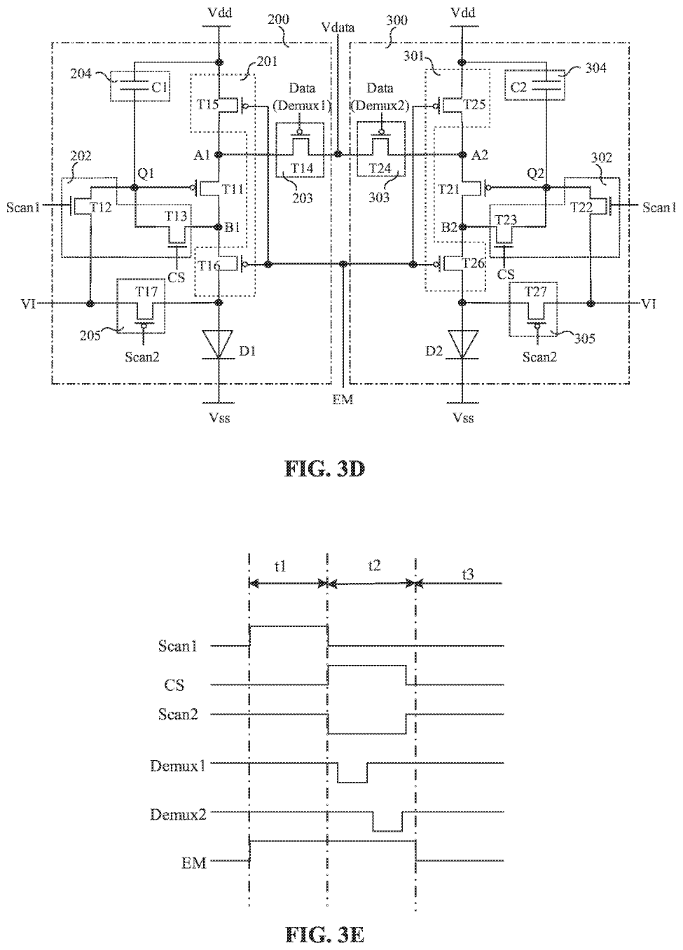

Specifically, please refer to FIG. 1, which is a schematic diagram of a display panel of an embodiment of the present disclosure. FIG. 2A to FIG. 2G are schematic diagrams of pixels of embodiments of the present disclosure. FIG. 3A is a schematic diagram showing an arrangement of pixel drive circuits of the embodiment of the present disclosure. FIG. 3B is a schematic diagram of a pixel drive circuit of the embodiment of the present disclosure. FIG. 3C and FIG. 3D are schematic diagrams of the pixel drive circuit of the embodiment of the present disclosure. FIG. 3E is an operation sequence diagram of the pixel drive circuit of the embodiment of the present disclosure.

An embodiment of the present disclosure provides a display panel, including a plurality of pixel units 100 and a plurality of pixel drive circuits. Each of the pixel units 100 includes a plurality of pixels 1001. At least one of the pixel drive circuits includes two different types of transistors, and at least one of the pixel drive circuits is configured to respond to a light-emitting control signal EM to simultaneously drive two adjacent sub-pixels in the same pixel 1001 or two adjacent sub-pixels in two adjacent pixels 1001. Therefore, a display uniformity is increased, and a display quality of the display panel is improved.

Specifically, please refer to FIG. 1 and FIG. 2A to FIG. 2G, one of the plurality of pixels 1001 includes a first pixel 101. The first pixel 101 includes a first sub-pixel 1011 and a second sub-pixel 1012 adjacent to the first sub-pixel 1011. At least one of the pixel drive circuits is configured to respond to the light-emitting control signal EM to simultaneously drive the first sub-pixel 1011 and the second sub-pixel 1012. Thus, the display panel employs one pixel drive circuit to control the first sub-pixel 1011 and the second sub-pixel 1012 to emit light simultaneously, which increases the display uniformity and improves the display quality of the display panel.

Furthermore, the pixel drive circuit is also configured to drive two adjacent sub-pixels in two adjacent pixels 1001. Specifically, please refer to FIG. 2B to FIG. 2G, the plurality of pixels 1001 include a first pixel 101 and a second pixel 102 that are adjacent to each other in a first direction (i.e., a y-direction). The first pixel 101 includes a first sub-pixel 1011 and a second sub-pixel 1012 adjacent to the first sub-pixel 1011, and the second pixel 102 comprises a third sub-pixel 1021 and a fourth sub-pixel 1022 adjacent to the third sub-pixel 1021. At least one of the pixel drive circuits is configured to respond to a light-emitting control signal EM to simultaneously drive the two adjacent sub-pixels of the first sub-pixel 1011, the second sub-pixel 1012, the third sub-pixel 1021, and the fourth sub-pixel 1022. Thus, two adjacent sub-pixels disposed in different pixels can emit light at the same time, which improves a display difference of sub-pixels in different pixels and improves the display uniformity.

Please refer to FIG. 2B, in the first direction (i.e., the y-direction), the first sub-pixel 1011 is arranged adjacent to the third sub-pixel 1021, and the second sub-pixel 1012 is arranged adjacent to the fourth sub-pixel 1022. At least one of the pixel drive circuits is configured to respond to a light-emitting control signal EM to simultaneously drive the first sub-pixel 1011 and the third sub-pixel 1021. At least one of the pixel drive circuits is configured to respond to a light-emitting control signal EM to simultaneously drive the second sub-pixel 1012 and the fourth sub-pixel 1022.

Similarly, in the first direction (i.e., the y-direction), the first sub-pixel 1011 is arranged adjacent to the fourth sub-pixel 1022, and the second sub-pixel 1012 is arranged adjacent to the third sub-pixel 1021. At least one of the pixel drive circuits is configured to respond to a light-emitting control signal EM to simultaneously drive the first sub-pixel 1011 and the fourth sub-pixel 1022. At least one of the pixel drive circuits is configured to respond to a light-emitting control signal EM to simultaneously drive the second sub-pixel 1012 and the third sub-pixel 1021.

In addition, in the first direction (the y-direction), the first sub-pixel 1011 to the fourth sub-pixel 1022 may also be arranged in sequence. Specifically, the first sub-pixel 1011 is adjacent to the second sub-pixel 1012, the third sub-pixel 1021 is adjacent to the second sub-pixel 1012, and the fourth sub-pixel 1022 is adjacent to the third sub-pixel 1021. At least one of the pixel drive circuits is configured to respond to a light-emitting control signal EM to simultaneously drive the second sub-pixel 1012 and the third sub-pixel 1021. As shown in FIG. 2C, alternatively, the first sub-pixel 1011 is adjacent to the second sub-pixel 1012, the third sub-pixel 1021 is adjacent to the first sub-pixel 1011, and the fourth sub-pixel 1022 is adjacent to the third sub-pixel 1021. At least one of the pixel drive circuits is configured to respond to a light-emitting control signal EM to simultaneously drive the first sub-pixel 1011 and the third sub-pixel 1021. Similarly, the first sub-pixel 1011 mat also be adjacent to the fourth sub-pixel 1022. Alternatively, a situation if the second sub-pixel 1012 is adjacent to the fourth sub-pixel 1022 will not be repeated here.

Colors of the first sub-pixel 1011, the second sub-pixel 1012, and the third sub-pixel 1021 are different, so that the display panel can realize color display through the first pixel 101 and the second pixel 102. The colors of the first sub-pixel 1011 to the fourth sub-pixel 1022 include at least one of red, green, blue, and white. Furthermore, the first sub-pixel 1011 is a red sub-pixel, the second sub-pixel 1012 is a blue sub-pixel, and the third sub-pixel 1021 is a green sub-pixel. Furthermore, the fourth sub-pixel 1022 has the same color as one of the first sub-pixel 1011, the second sub-pixel 1012, or the third sub-pixel 1021. It is understandable that the fourth sub-pixel 1022 may also be a sub-pixel of other colors, which will not be repeated here.

In addition, other pixels can be added to the pixel units 100 to realize the color display of the display panel and improve the display quality of the display panel. Specifically, referring to FIG. 2D to FIG. 2G, the plurality of pixels 1001 also include a third pixel 103 and a fourth pixel 104 which are adjacent to each other in the first direction (y-direction). The third pixel 103 includes a fifth sub-pixel 1031 and a sixth sub-pixel 1032 adjacent to the fifth sub-pixel 1031, and the fourth pixel 104 includes a seventh sub-pixel 1041 and an eighth sub-pixel 1042 adjacent to the seventh sub-pixel 1041. At least one of the pixel drive circuits is configured to respond to a light-emitting control signal EM to simultaneously drive two adjacent sub-pixels of the first sub-pixel 1011 to the eighth sub-pixel 1042.

Specifically, referring to FIG. 2D, colors of the first pixel 101, the second pixel 102, and the third pixel 103 are different, colors of the third pixel 103 and the fourth pixel 104 are the same, colors of the first sub-pixel 1011 and the second sub-pixel 1012 are the same, colors of the third sub-pixel 1021 and the fourth sub-pixel 1022 are the same, colors of the fifth sub-pixel 1031, the sixth sub-pixel 1032, the seventh sub-pixel 1041, and the eighth sub-pixel 1042 are the same. In a second direction (i.e., an x-direction) intersecting the first direction (y-direction), the third pixel 103 is adjacent to the first pixel 101, and the fourth pixel 104 is adjacent to the second pixel 102.

Furthermore, in the first direction (y-direction), the first sub-pixel 1011 is adjacent to the third sub-pixel 1021, the second sub-pixel 1012 is adjacent to the fourth sub-pixel 1022, and the fifth sub -pixel 1031 is adjacent to the seventh sub-pixel 1041, and the sixth sub-pixel 1032 is adjacent to the eighth sub-pixel 1042. In the second direction (x-direction), the first sub-pixel 1011, the second sub-pixel 1012, the fifth sub-pixel 1031, and the sixth sub-pixel 1032 are arranged in sequence, and third sub-pixel 1021, the fourth sub-pixel 1022, the seventh sub-pixel 1041, and the eighth sub-pixel 1042 are arranged in sequence. At least one of the pixel drive circuits is configured to simultaneously drive the first sub-pixel 1011 and the third sub-pixel 1021, and at least one of the pixel drive circuits is configured to simultaneously drive the sixth sub-pixel 1032 and the eighth sub-pixel 1042, at least one of the pixel drive circuits is configured to simultaneously drive the second sub-pixel 1012 and the fourth sub-pixel 1022, and at least one of the pixel drive circuits is configured to simultaneously drive the fifth sub-pixel 1031 and the seventh sub-pixel 1041. Alternatively, at least one of the pixel drive circuits is configured to simultaneously drive the second sub-pixel 1012 and the fifth sub-pixel 1031, and at least one of the pixel drive circuits is configured to drive the fourth sub-pixel 1022 and the seventh sub-pixel 1041 simultaneously.

Colors of the first sub-pixel 1011 to the eighth sub-pixel 1042 include at least one of red, green, blue, and white. Furthermore, the first sub-pixel 1011 and the second sub-pixel 1012 are red sub-pixels, the third sub-pixel 1021 and the fourth sub-pixel 1022 are blue sub-pixels, the fifth sub-pixel 1031, the sixth sub-pixel 1032, the seventh sub-pixel 1041, and the eighth sub-pixel 1042 are green sub-pixels.

Similarly, referring to FIG. 2E, colors of the first pixel 101 and the third pixel 103 are the same, colors of the second pixel 102 and the fourth pixel 104 are the same, colors of the first sub-pixel 1011, the second sub-pixel 1012, and the third sub-pixel 1021 are different. In the second direction (x-direction), the third pixel 103 is adjacent to the first pixel 101, and the fourth pixel 104 is adjacent to the second pixel 102.

Furthermore, in the first direction (y-direction), the second sub-pixel 1012 is adjacent to the third sub-pixel 1021, the first sub-pixel 1011 is adjacent to the fourth sub-pixel 1022, the fifth sub -pixel 1031 is adjacent to the eighth sub-pixel 1042, and the sixth sub-pixel 1032 is adjacent to the seventh sub-pixel 1041. In the second direction (x-direction), the second sub-pixel 1012, the first sub-pixel 1011, the fifth sub-pixel 1031, and the sixth sub-pixel 1032 are arranged in sequence, and the third sub-pixel 1021, the fourth sub-pixel 1022, the eighth sub-pixel 1042, and the seventh sub-pixel 1041 are arranged in sequence. At least one of the pixel drive circuits is configured to simultaneously drive the first sub-pixel 1011 and the second sub-pixel 1012. At least one of the pixel drive circuits is configured to simultaneously drive the third sub-pixel 1021 and the fourth sub-pixel 1022. At least one of the pixel drive circuits is configured to simultaneously drive the fifth sub-pixel 1031 and the eighth sub-pixel 1042. At least one of the pixel drive circuits is configured to simultaneously drive the sixth sub-pixel 1032 and the seventh sub-pixel 1041.

Colors of the first sub-pixel 1011 to the eighth sub-pixel 1042 include at least one of red, green, blue, and white. Furthermore, the first sub-pixel 1011 is a blue sub-pixel, the second sub-pixel 1012 is a red sub-pixel, and the third sub-pixel 1021 is a green sub-pixel. Furthermore, the fifth sub-pixel 1031 has the same color as one of the first sub-pixel 1011 and the second sub-pixel 1012, and the sixth sub-pixel 1032 has the same color as the other one of the first sub-pixel 1011 and the second sub-pixel 1012. Furthermore, colors of the third sub-pixel 1021 and the fourth sub-pixel 1022 are the same, and colors of the third pixel 103 and the fourth pixel 104 are the same.

Similarly, referring to FIG. 2F, colors of the first pixel 101 and the third pixel 103 are the same, colors of the second pixel 102 and the fourth pixel 104 are the same, colors of the first sub-pixel 1011, the second sub-pixel 1012, and the third sub-pixel 1021 are different. In the second direction (x-direction), the third pixel 103 is adjacent to the second pixel 102, and the fourth pixel 104 is adjacent to the first pixel 101.

Furthermore, in the first direction (y-direction), the first sub-pixel 1011 is adjacent to the fourth sub-pixel 1022, the second sub-pixel 1012 is adjacent to the third sub-pixel 1021, the sixth sub-pixel 1032 is adjacent to the eighth sub-pixel 1042, and the seventh sub-pixel 1041 is adjacent to the fifth sub-pixel 1031. In the second direction (x-direction), the first sub-pixel 1011, the second sub-pixel 1012, the eighth sub-pixel 1042, and the seventh sub-pixel 1041 are arranged in sequence, and the fourth sub-pixel 1022, the third sub-pixel 1021, the sixth sub-pixel 1032, and the fifth sub-pixel 1031 are arranged in sequence. At least one of the pixel drive circuits is configured to simultaneously drive the first sub-pixel 1011 and the fourth sub-pixel 1022. At least one of the pixel drive circuits is configured to simultaneously drive the seventh sub-pixel 1041 and the fifth sub-pixel 1031. At least one of the pixel drive circuits is configured to simultaneously drive the second sub-pixel 1012 and the eighth sub-pixel 1042. At least one of the pixel drive circuits is configured to simultaneously drive the sixth sub-pixel 1032 and the third sub-pixel 1021.

Furthermore, colors of the first sub-pixel 1011 to the eighth sub-pixel 1042 include at least one of red, green, blue, and white. Furthermore, the first sub-pixel 1011 is a red sub-pixel, the second sub-pixel 1012 is a blue sub-pixel, and the third sub-pixel 1021 is a green sub-pixel. Furthermore, the fifth sub-pixel 1031 has the same color as one of the first sub-pixel 1011 and the second sub-pixel 1012, and the sixth sub-pixel 1032 has the same color as the other one of the first sub-pixel 1011 and the second sub-pixel 1012. Furthermore, colors of the third sub-pixel 1021 and the fourth sub-pixel 1022 are the same, and colors of the third pixel 103 and the fourth pixel 104 are the same.

It can be understood that the first direction and the second direction are not limited to crossing vertically. The first direction and the second direction can be replaced with each other. Number of the sub-pixels in the first pixel 101 to the fourth pixel 104 is not limited to two. As shown in FIG. 2G, the first pixel 101 may further include a ninth sub-pixel 1013 adjacent to the first sub-pixel 1011 and/or the second sub-pixel 1012. The second pixel 102 also includes a tenth sub-pixel 1023 adjacent to the third sub-pixel 1021 and the fourth sub-pixel 1022. At least one pixel drive circuit is configured to simultaneously drive any two adjacent sub-pixels in the first pixel 101 and the second pixel 102. Furthermore, colors of the ninth sub-pixel 1013 and the tenth sub-pixel 1023 includes at least one of blue, red, and green.

Positions of the adjacent sub-pixels in each of the pixels 1001 can be adjusted according to actual needs, and the arrangements in FIG. 2A to FIG. 2G are only exemplary illustrations. Shape of the sub-pixels is not limited to rectangles, but can also be round, diamond, etc., which can be adjusted by those skilled in the art according to actual needs. The arrangement of the pixel drive circuits in FIG. 3A is also only an exemplary illustration. In FIG. 3A, A and B represent one of the pixel drive circuits, and SP represents sub-pixels.

Referring to FIG. 1, in the display panel, horizontally adjacent pixel units 100 may be arranged in a horizontal mirror image, and longitudinally adjacent pixel units 100 may be arranged in a vertical mirror image. Specifically, two horizontally adjacent pixel units 100a and 100b have the plurality of pixels 1001. The pixels 1001 located in the pixel unit 100a and the pixels 1001 located in the pixel unit 100b are arranged in a mirror image with a gap 100d between the pixel units 100a and 100b as a symmetry axis. Furthermore, the plurality of sub-pixels located in the pixel unit 100a and the plurality of sub-pixels located in the pixel unit 100b are arranged in a mirror image with the gap 100d as the symmetry axis.

Similarly, each of two longitudinally adjacent pixel units 100a and 100c has a plurality of pixels 1001. The pixels 1001 located in the pixel unit 100a and the pixels 1001 located in the pixel unit 100c are arranged in a mirror image with a gap 100e between the pixel units 100a and 100c as a symmetry axis. Furthermore, the plurality of sub-pixels located in the pixel unit 100a and the plurality of sub-pixels located in the pixel unit 100c are arranged in a mirror image with the gap 100e as the symmetry axis.

In addition, the plurality of pixels 1001 in the pixel units 100a, 100b, and 100c can be arranged in the same arrangement or other arrangements, which will not be repeated here.

Referring to FIG. 3B to FIG. 3E, each of the pixel drive circuits includes a first sub-circuit 200, a second sub-circuit 300, and a switch module. The first sub-circuit 200 includes a first drive transistor T11. The first drive transistor T11 is configured to provide a first drive current. The second sub-circuit 300 includes a second drive transistor T21. The second drive transistor T21 is configured to provide a second drive current. The switch module is configured to respond to the light-emitting control signal EM, and use the first drive current and the second drive current to respectively control the two adjacent sub-pixels to emit light.

Specifically, referring to FIG. 3B to FIG. 3D, taking at least one of the pixel drive circuits simultaneously driving the first sub-pixel 1011 and the second sub-pixel 1012 as an example, the pixel drive circuit include the first sub-pixel 1011 and the second sub-pixel 1012. The first sub-pixel 1011 includes a first light-emitting device D1. The second sub-pixel 1012 includes a second light-emitting device D2.

The switch module includes a first switch module 201 and a second switch module 301. The first switch module 201 includes a first switch transistor T15 and a second switch transistor T16. One of a source or a drain of the first switch transistor T15 is connected to a first voltage terminal Vdd, and the other of the source or the drain of the first switch transistor T15 is connected to one of a source or a drain of the first drive transistor T11. One of a source or a drain of the second switch transistor T16 is connected to the other of the source or the drain of the first drive transistor T11, and the other of the source or the drain of the second switch transistor T16 is connected to an anode of the first light-emitting device D1. The first switch transistor T15 and the second switch transistor T16 are configured to control the first light-emitting device D1 to emit light in response to the light-emitting control signal EM.

The second switch module 301 includes a third switch transistor T25 and a fourth switch transistor T26. One of a source or a drain of the third switch transistor T25 is connected to the first voltage terminal Vdd, and the other of the source or the drain of the third switch transistor T25 is connected to one of a source or a drain of the second drive transistor T21. One of a source or a drain of the fourth switch transistor T26 is connected to the other of the source or the drain of the second drive transistor T21, and the other of the source or the drain of the fourth switch transistor T26 is connected to an anode of the second light-emitting device D2. The third switch transistor T25 and the fourth switch transistor T26 are configured to control the second light-emitting device D2 to emit light in response to the light-emitting control signal EM, so as to realize simultaneous driving of the first sub-pixel 1011 and the second sub-pixel 1012 under a control of the same light-emitting control signal EM.

Referring to FIG. 3B to FIG. 3D, the first sub-circuit 200 also includes a first compensation module 202. The first compensation module 202 includes a first initialization transistor T12 and a first compensation transistor T13 that are different in type from the first drive transistor T11. The first initialization transistor T12 is configured to respond to the first scan signal Scan1 and transmit an initialization signal VI to a gate of the first drive transistor T11 to initialize a gate voltage of the first drive transistor T11. The first compensation transistor T13 is configured to compensate a threshold voltage of the first drive transistor T11 in response to a compensation control signal CS.

The second sub-circuit 300 also includes a second compensation module 302. The second compensation module 302 includes a second initialization transistor T22 and a second compensation transistor T23 that are different in type from the second drive transistor T21. The second initialization transistor T22 is configured to respond to the first scan signal Scan1 and transmit the initialization signal VI to a gate of the second drive transistor T21 to initialize a gate voltage of the second drive transistor T21. The second compensation transistor T23 is configured to compensate a threshold voltage of the second drive transistor T21 in response to the compensation control signal CS.

Furthermore, the first drive transistor T11 and the second drive transistor T21 are silicon transistors or oxide transistors, the first initialization transistor T12, the first compensation transistor T13, the second initialization transistor T22, and the second compensation transistor T23 are silicon transistors or oxide transistors. Furthermore, the first drive transistor T11 and the second drive transistor T21 are silicon transistors, the first initialization transistor T12, the first compensation transistor T13, the second initialization transistor T22, and the second compensation transistor T23 are oxide transistors such that an influence of one of the source or the drain of the first drive transistor T11 on the gate of the first drive transistor T11 is reduced, and an influence of one of the source or the drain of the second drive transistor T21 on the gate of the second drive transistor T21 is reduced, which is beneficial to the display panel to realize ultra-low frequency and ultra-low power consumption.

The first drive transistor T11, the second drive transistor T21, the first initialization transistor T12, the first compensation transistor T13, the second initialization transistor T22, and the second compensation transistor T23 are at least one of a P-type transistor or an N-type transistor.

Referring to FIG. 3B to FIG. 3D, the pixel drive circuit also includes a data writing module and a storage module. The data writing module includes a data transistor. The data transistor is configured to respond to a data control signal Data and transmit a data signal to the gate of the first drive transistor T11 and the gate of the second drive transistor T21. The storage module includes a storage capacitor. The storage capacitor is configured to maintain the gate voltage of the first drive transistor T11 and the gate voltage of the second drive transistor T21. The data control signal Data includes at least one of a scan signal and a demultiplexing signal.

Specifically, referring to FIG. 3C to FIG. 3D, the demultiplexing signal includes a first demultiplexing signal Demux1 and a second demultiplexing signal Demux2. The data writing module includes a first data writing module 203 and a second data writing module 303. Each of the first data writing module 203 and the second data writing module 303 includes the data transistor. Specifically, the data transistor includes a first data transistor T14 and a second data transistor T24. The first data transistor T14 is configured to respond to the second scan signal Scan2 or the first demultiplexing signal Demux1 and transmit the data signal Vdata or Vdata1 to the gate of the first drive transistor T11. The second data transistor T24 is configured to respond to the second scan signal Scan2 or the second demultiplexing signal Demux2 and transmit the data signal Vdata or Vdata2 to the gate of the second drive transistor T21.

Since the scan signal must be converted by a gate driving circuit, etc., compared to using the scan signal to control the data transistor, using the demultiplexing signal to control the data transistor is more conducive to a realization of ultra-high frequency in the display panel. The first demultiplexing signal Demux1 and the second demultiplexing signal Demux2 may have the same timing or different timings, so as to implement time-sharing writing of the data signal.

Referring to FIG. 3C, one of a source or a drain of the first data transistor T14 and a source of the first drive transistor T11 are connected to an A1 node. One of a source or a drain of the second data transistor T24 and a drain of the first drive transistor T21 are connected to an A2 node. The first sub-circuit 200 can be configured to drive sub-pixels that are more sensitive to current. Specifically, the drain of the first data transistor T14 and the source of the first drive transistor T11 are connected to the A1 node. The drain of the second data transistor T24 and the drain of the first drive transistor T21 are connected to the A2 node. Since sub-pixels that emit green light are more sensitive to current than sub-pixels that emit red or blue light, the first sub-circuit 200 can be configured to drive sub-pixels that emit green light. The second sub-circuit 300 can be configured to drive sub-pixels that emit red or blue light, so as to improve light-emitting stability between sub-pixels that emit different colors.

Referring to FIG. 3B to FIG. 3D, the storage module includes a first storage module 204 and a second storage module 304. The first storage module 204 includes a first storage capacitor C1 connected in series between the first voltage terminal Vdd and the gate of the first drive transistor T11. The first storage capacitor C1 is configured to maintain the gate voltage of the first drive transistor T11. The second storage module 304 includes a second storage capacitor C2 connected in series between the first voltage terminal Vdd and the gate of the second drive transistor T21. The second storage capacitor C2 is configured to maintain the gate voltage of the second drive transistor T21.

Referring to FIG. 3B to FIG. 3D, the two adjacent sub-pixels include two light-emitting devices. The pixel drive circuit also includes a reset module. The reset module is configured to respond to the second scan signal Scan2 and transmit a reset signal VI to anodes of the two light-emitting devices. Cathodes of the two light-emitting devices are connected to a second voltage terminal Vss.

Specifically, taking the first sub-pixel 1011 including a first light-emitting device D1 and the second sub-pixel 1012 including a second light-emitting device D2 as an example, the reset module includes a first reset module 205 and a second reset module 305. The first reset module 205 includes a first reset transistor T17. One of a source or a drain of the first reset transistor T17 is connected to an anode of the first light-emitting device D1. The first reset transistors T17 is configured to transmit the reset signal VI to the anode of the first light-emitting device D1 in response to the second scan signal Scan2.

The second reset module 305 includes a second reset transistor T27. One of a source or a drain of the second reset transistor T27 is connected to an anode of the second light-emitting device D2. The second reset transistor T27 is configured to transmit the reset signal VI to the anode of the second light-emitting device D2 in response to the second scan signal Scan2.

Referring to FIG. 3C to FIG. 3E, taking the first drive transistor T11, the second drive transistor T21, the first data transistor T14, the second data transistor T24, the first switch transistor T15, the second switch transistor T16, the third switch transistor T25, the fourth switch transistor T26, the first reset transistor T17, and the second reset transistor T27 being P-type silicon transistors, and the first initialization transistor T12, the second initialization transistor T22, the first compensation transistor T13, and the second compensation transistor T23 being N-type oxide transistors as an example, a driving principle of the pixel drive circuit will be described. In FIG. 3C, the first data transistor T14, the second data transistor T24, the first reset transistor T17, and the second reset transistor T27 share the second scan signal Scan2. In FIG. 3D, the first demultiplexing signal Demux1 and the second demultiplexing signal Demux2 are configured to control the first data transistor T14 and the second data transistor T24, respectively. An operation process of the pixel drive circuit includes the following.

In an initialization stage t1, the first scan signal Scan1, the second scan signal Scan2, and the light-emitting control signal EM are at a high level, and the compensation control signal CS is at a low level. The first initialization transistor T12 and the second initialization transistor T22 are turned on. The reset signal VI is transmitted to the gate of the first drive transistor T11 (node Q1) and the gate of the second drive transistor T21 (node Q2) to initialize the gate voltages of the first drive transistor T11 and the second drive transistor T21.

In the data writing stage t2, the first scan signal Scan1, the second scan signal Scan2 are at a low level, and the light-emitting control signal EM and the compensation control signal CS are at a high level. The first reset transistor T17 and the second reset transistor T27 are turned on in response to the second scan signal Scan2. The reset signal VI is transmitted to the anodes of the first light-emitting device D1 and the second light-emitting device D2 to initialize anode voltages of the first light-emitting device D1 and the second light-emitting device D2.

In the pixel drive circuit shown in FIG. 3C, the first compensation transistor T13 and the second compensation transistor T23 are turned on in response to the compensation control signal CS. The first data transistor T14 and the second data transistor T24 are turned on in response to the second scan signal Scan2. The data signals Vdata1 and Vdata2 are respectively transmitted to the A1 node and the A2 node, respectively. The data signals Vdata1 and Vdata2 that have a function of compensating the threshold voltage are respectively transmitted to the gate of the first drive transistor T11 and the gate of the second drive transistor T21 through the first compensation transistor T13 and the second compensation transistor T23 to compensate the threshold voltages of the first drive transistor T11 and the second drive transistor T21.

In the pixel drive circuit shown in FIG. 3D, the data writing stage t2 further includes the following.

In a first data writing stage, the first demultiplexing signal Demux1 is at a low level, and the second demultiplexing signal Demux2 is at a high level. The first compensation transistor T13 and the second compensation transistor T23 are turned on in response to the compensation control signal CS. The first data transistor T14 is turned on in response to the first demultiplexing signal Demux1. The data signal Vdata is transmitted to the A1 node. The first compensation transistor T13 is turned on so that the data signal Vdata having the function of compensating the threshold voltage is transmitted to the gate of the first drive transistor T11 to compensate the threshold voltage of the first drive transistor T11.

In a second data writing stage, the first demultiplexing signal Demux1 is at a high level, and the second demultiplexing signal Demux2 is at a low level. The first compensation transistor T13 and the second compensation transistor T23 are turned on in response to the compensation control signal CS. The second data transistor T24 is turned on in response to the second demultiplexing signal Demux2. The data signal Vdata is transmitted to the A2 node. The second compensation transistor T23 is turned on so that the data signal Vdata having the function of compensating the threshold voltage is transmitted to the gate of the second drive transistor T21 to compensate the threshold voltage of the second drive transistor T21.

In order to ensure that the data signal Vdata can be transmitted to the A1 node and the A2 node in a time-sharing manner during the data writing stage t2, frequencies of the first demultiplexing signal Demux1 and the second demultiplexing signal Demux2 are greater than or equal to twice a frequency of the compensation control signal CS to ensure enough data writing time. Timings of the first demultiplexing signal Demux1 and the second demultiplexing signal Demux2 may be the same or different, that is, the frequency and phase of the first demultiplexing signal Demux1 and the second demultiplexing signal Demux2 may be the same or different.

In a light-emitting stage t3, the first scan signal Scan1, the compensation control signal CS, and the light-emitting control signal EM are at a low level, and the second scan signal Scan2 is at a high level. In FIG. 3D, the first demultiplexing signal Demux1 and the second demultiplexing signal Demux2 are at the high level. The first switch transistor T15, the second switch transistor T16, the third switch transistor T25, and the fourth switch transistor T26 are turned on. The first drive transistor T11 and the second drive transistor T21 respectively generate the first drive current and the second drive current to simultaneously drive the first light-emitting device D1 and the second light-emitting device D2 to emit light. The first compensation transistor T13 in a turned off state is used to reduce an influence of a B1 node on the gate of the first drive transistor T11. The second compensation transistor T23 is used to reduce an influence of a node B2 on the gate of the second drive transistor T21. That is, an influence on the gate voltages of the first drive transistor T11 and the second drive transistor T21 is reduced, thereby ensuring the light-emitting stability of the light-emitting devices.

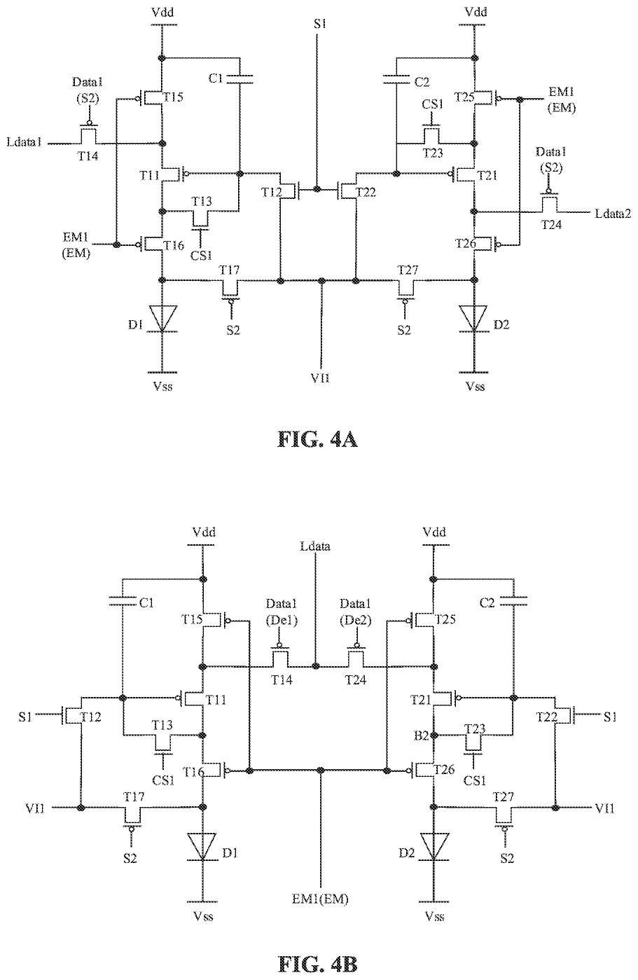

Referring to FIG. 4A to FIG. 4B, which are schematic diagrams of a pixel drive circuit of an embodiment of the present disclosure. The present disclosure also provides a display panel, including a plurality of pixels and a plurality of pixel drive circuits. The plurality of pixels include a first sub-pixel and a second sub-pixel adjacent to the first sub-pixel, the first sub-pixel includes a first light-emitting device D1, and the second sub-pixel includes a second light-emitting device D2. At least one of the pixel drive circuits includes two different types of transistors, the pixel drive circuits is configured to respond to a light-emitting control signal EM to simultaneously drive two adjacent sub-pixels in the same pixel or two adjacent sub-pixels in two adjacent pixels. One of the pixel drive circuits includes a first transistor T11 and an eighth transistor T21. The first transistor is configured to provide a first drive current to drive the first sub-pixel or the second sub-pixel to emit light. The eighth transistor is configured to provide a second drive current to drive the first sub-pixel or the second sub-pixel to emit light. The same light-emitting control signal EM is used to realize a light-emitting control of any two adjacent sub-pixels, thereby improving a display uniformity.

Referring to FIG. 4A to FIG. 4B, the pixel drive circuit further includes a fifth transistor T15, a sixth transistor T16, a twelfth transistor T25, and a thirteenth transistor T26. A gate of the fifth transistor T15 is connected to a light-emitting control signal line EM1, one of a source or a drain of the fifth transistor T15 is connected to a first voltage terminal Vdd, and the other of the source or the drain of the fifth transistor T15 is connected to one of a source or a drain of the first transistor T11. A gate of the sixth transistor T16 is connected to the light-emitting control signal line EM1, one of a source or a drain of the sixth transistor T16 is connected to one of the source or the drain of the first transistor T11, the other of the source or the drain of the sixth transistor T16 is connected to an anode of the first light-emitting device D1. A gate of the twelfth transistor T25 is connected to the light-emitting control signal line EM1, one of a source or a drain of the twelfth transistor T25 is connected to the first voltage terminal Vdd, and the other of the source or the drain of the twelfth transistor T25 is connected to one of a source or a drain of the eighth transistor T21. A gate of the thirteenth transistor T26 is connected to the light-emitting control signal line EM1, one of a source or a drain of the thirteenth transistor T26 is connected to one of the source or the drain of the eighth transistor T21, and the other of the source or the drain of the thirteenth transistor T26 is connected to an anode of the second light-emitting device D2.

Referring to FIG. 4A to FIG. 4B, the pixel drive circuit further includes a third transistor T13 and a tenth transistor T23. A gate of the third transistor T13 is connected to a compensation control signal line CS1, one of a source or a drain of the third transistor T13 is connected to a gate of the first transistor T11, and the other of the source or the drain of the third transistor T13 is connected to one of a source or a drain of the first transistor T11. A gate of the tenth transistor T23 is connected to the compensation control signal line CS1, one of a source or a drain of the tenth transistor T23 is connected to a gate of the eighth transistor T21, and the other of the source or the drain of the tenth transistor T23 is connected to one of a source or a drain of the eighth transistor T21. Semiconductor layers of the first transistor T11 and the third transistor T13 are made of different materials, and semiconductor layers of the eighth transistor T21 and the tenth transistor T23 are made of different materials.

Furthermore, the first transistor T11 and the eighth transistor T21 include a silicon semiconductor layer or an oxide semiconductor layer. The third transistor T13 and the tenth transistor T23 include a silicon semiconductor layer or an oxide semiconductor layer. Furthermore, the first transistor T11 and the eighth transistor T21 include a silicon semiconductor layer, and the third transistor T13 and the tenth transistor T23 include an oxide semiconductor layer. A low leakage current characteristic of the third transistor T13 is used to reduce an influence of one of the source or the drain of the first transistor T11 on the gate. Utilizing the low leakage current characteristic of the tenth transistor T23 reduces the low leakage current characteristic of the eighth transistor T21. Therefore, luminescence stability of sub-pixels is ensured.

Referring to FIG. 4A to FIG. 4B, the pixel drive circuit also includes a second transistor T12 and a ninth transistor T22. A gate of the second transistor T12 is connected to a first scan signal line S1. One of a source or a drain of the second transistor T12 is connected to the gate of the first transistor T11. The other of the source or the drain of the second transistor T12 is connected to a reset signal line VI1. A gate of the ninth transistor T22 is connected to the first scan signal line S1. One of a source or a drain of the ninth transistor T22 is connected to a gate of the eighth transistor T21. The other of the source or the drain of the ninth transistor T22 is connected to the reset signal line VI1.

Furthermore, semiconductor layers of the first transistor T11 and the second transistor T12 are made of different materials. Semiconductor layers of the eighth transistor T21 and the ninth transistor T22 are made of different materials. Furthermore, the eighth transistor T21 and the ninth transistor T22 include an oxide semiconductor layer.

Referring to FIG. 4A to FIG. 4B, the pixel drive circuit further includes a first storage capacitor C1, a second storage capacitor C2, a fourth transistor T14, and an eleventh transistor T24. The first storage capacitor C1 is connected in series between a first voltage terminal Vdd and a gate of the first transistor T11. The second storage capacitor C2 is connected in series between the first voltage terminal Vdd and a gate of the eighth transistor T21. A gate of the fourth transistor T14 is connected to a data control signal line Data1, one of a source or a drain of the fourth transistor T14 is connected to one of a source or a drain of the first transistor T11, and the other of the source or the drain of the fourth transistor T14 is connected to a data line Ldata or a data line Ldata1. A gate of the eleventh transistor T24 is connected to the data control signal line Data1, one of a source or a drain of the eleventh transistor T24 is connected to one of a source or a drain of the eighth transistor T21, and the other of the source or the drain of the eleventh transistor T24 is connected to the data line Ldata or a data line Ldata2. A data control signal loaded in the data control signal line Data1 includes at least one of a scan signal and a demultiplexing signal. Specifically, the data control signal line Data1 can be shared with a second scan signal line S2, as shown in FIG. 4A. The data control signal line Data1 may be a demultiplexing signal line loaded with a demultiplexing signal. The demultiplexing signal line includes a first demultiplexing signal line De1 connected to a gate of the fourth transistor T14 and a second demultiplexing signal line De2 connected to a gate of the eleventh transistor T24. Replacing the scan signal with the demultiplexing signal to control the fourth transistor T14 and the eleventh transistor T24 facilitates the display panel to achieve high frequency display. The time-sharing writing of data can be realized by using two demultiplexing signal lines.

Referring to FIG. 4A to FIG. 4B, the pixel drive circuit further includes a seventh transistor T17 and a fourteenth transistor T27. A gate of the seventh transistor T17 is connected to a second scan signal line S2, one of a source or a drain of the seventh transistor T17 is connected to a reset signal line VI1, and the other of the source or the drain of the seventh transistor T17 is connected to an anode of the first light-emitting device D1. A gate of the fourteenth transistor T27 is connected to a second scan signal line S2, one of a source or a drain of the fourteenth transistor T27 is connected to the reset signal line VI1, and the other of the source or the drain of the fourteenth transistor T27 is connected to an anode of the second light-emitting device D2. A cathode of the first light-emitting device D1 and a cathode of the second light-emitting device D2 are connected to a second voltage terminal Vss.

The first light-emitting device D1 and the second light-emitting device D2 include at least one of organic light-emitting diodes, sub-millimeter light-emitting diodes, and miniature light-emitting diodes.

The present disclosure also provides a display device including the display panel. Furthermore, the display device also includes a sensor. The sensor includes a fingerprint recognition sensor, a camera, a structured light sensor, a time-of-flight sensor, a distance sensor, a light sensor, etc., to realize fingerprint recognition, camera, face recognition, distance sensing, and other functions. Furthermore, the display panel may also include a color film layer and other parts not shown.

The foregoing embodiments are only intended for describing the technical solutions and core ideas of the present disclosure. Persons of ordinary skill in the art should understand that they may still make modifications to the technical solutions described in the foregoing embodiments or make equivalent replacements to some technical features of the technical solutions, as long as these modifications or replacements do not make the essence of corresponding technical solutions depart from the scope of the technical solutions in the embodiments of the present disclosure.

What is claimed is:

1. A display panel, comprising:
a plurality of pixel units, wherein each of the pixel units comprises a plurality of pixels; and
a plurality of pixel drive circuits, wherein at least one of the pixel drive circuits comprises two different types of transistors, and at least one of the pixel drive circuits is configured to respond to a light-emitting control signal to simultaneously drive two adjacent sub-pixels in the same pixel or two adjacent sub-pixels in two adjacent pixels.

2. The display panel as claimed in claim 1, wherein the plurality of pixels comprise a first pixel, the first pixel comprises a first sub-pixel and a second sub-pixel adjacent to the first sub-pixel, and at least one of the pixel drive circuits is configured to respond to the light-emitting control signal to simultaneously drive the first sub-pixel and the second sub-pixel.

3. The display panel as claimed in claim 1, wherein the plurality of pixels comprise a first pixel and a second pixel that are adjacent to each other in a first direction, the first pixel comprises a first sub-pixel and a second sub-pixel adjacent to the first sub-pixel, and the second pixel comprises a third sub-pixel and a fourth sub-pixel adjacent to the third sub-pixel; and
at least one of the pixel drive circuits is configured to respond to the light-emitting control signal to simultaneously drive the two adjacent sub-pixels of the first sub-pixel, the second sub-pixel, the third sub-pixel, and the fourth sub-pixel.

4. The display panel as claimed in claim 3, wherein the plurality of pixels further comprise a third pixel and a fourth pixel that are adjacent to each other in the first direction, the third pixel comprises a fifth sub-pixel and a sixth sub-pixel adjacent to the fifth sub-pixel, and the fourth pixel comprises a seventh sub-pixel and an eighth sub-pixel adjacent to the seventh sub-pixel; and
at least one of the pixel drive circuits is configured to respond to the light-emitting control signal to simultaneously drive the two adjacent sub-pixels of the first sub-pixel to the eighth sub-pixel.

5. The display panel as claimed in claim 4, wherein colors of the first pixel, the second pixel, and the third pixel are different, colors of the third pixel and the fourth pixel are the same, colors of the first sub-pixel and the second sub-pixel are the same, colors of the third sub-pixel and the fourth sub-pixel are the same, colors of the fifth sub-pixel, the sixth sub-pixel, the seventh sub-pixel, and the eighth sub-pixel are the same, and in a second direction intersecting the first direction, the third pixel is adjacent to the first pixel, and the fourth pixel is adjacent to the second pixel; or
colors of the first pixel and the third pixel are the same, colors of the second pixel and the fourth pixel are the same, colors of the first sub-pixel, the second sub-pixel, and the third sub-pixel are different, and in the second direction, the third pixel is adjacent to the first pixel, and the fourth pixel is adjacent to the second pixel; or
the colors of the first pixel and the third pixel are the same, the colors of the second pixel and the fourth pixel are the same, the colors of the first sub-pixel, the second sub-pixel, and the third sub-pixel are different, and in the second direction, the third pixel is adjacent to the second pixel, and the fourth pixel is adjacent to the first pixel.

6. The display panel as claimed in claim 1, wherein each of the pixel drive circuits comprises:
a first sub-circuit comprising a first drive transistor, wherein the first drive transistor is configured to provide a first drive current;
a second sub-circuit comprising a second drive transistor, wherein the second drive transistor is configured to provide a second drive current; and
a switch module configured to respond to the light-emitting control signal, and use the first drive current and the second drive current to respectively control the two adjacent sub-pixels to emit light.

7. The display panel as claimed in claim 6, wherein the first sub-circuit further comprises a first compensation module, the first compensation module comprises a first initialization transistor and a first compensation transistor which are different in type from the first drive transistor, the first initialization transistor is configured to respond to a first scan signal and transmit an initialization signal to a gate of the first drive transistor to initialize a gate voltage of the first drive transistor, and the first compensation transistor is configured to compensate for a threshold voltage of the first driving transistor in response to a compensation control signal; and
the second sub-circuit further comprises a second compensation module, the second compensation module comprises a second initialization transistor and a second compensation transistor which are different in type from the second drive transistor, the second initialization transistor is configured to respond to the first scan signal and transmit the initialization signal to a gate of the second drive transistor to initialize a gate voltage of the second drive transistor, and the second compensation transistor is configured to compensate for a threshold voltage of the second drive transistor in response to the compensation control signal.

8. The display panel as claimed in claim 7, wherein the first drive transistor and the second drive transistor are silicon transistors, the first initialization transistor, the first compensation transistor, the second initialization transistor, and the second compensation transistor are oxide transistors.

9. The display panel as claimed in claim 6, wherein one of the pixel drive circuits further comprises:
a data writing module comprising a data transistor, wherein the data transistor is configured to respond to a data control signal and transmit a data signal to a gate of the first drive transistor and a gate of the second drive transistor; and
a storage module comprising a storage capacitor, wherein the storage capacitor is configured to maintain a gate voltage of the first drive transistor and a gate voltage of the second drive transistor; and
wherein the data control signal comprises at least one of a scan signal and a demultiplexing signal.

10. The display panel as claimed in claim 9, wherein the demultiplexing signal comprises a first demultiplexing signal and a second demultiplexing signal, and the data transistor comprises:
a first data transistor configured to respond to the first demultiplexing signal and transmit the data signal to the gate of the first drive transistor; and
a second data transistor configured to respond to the second demultiplexing signal and transmit the data signal to the gate of the second drive transistor.

11. The display panel as claimed in claim 1, wherein the two adjacent sub-pixels comprise two light-emitting devices, one of the pixel drive circuits further comprises a reset module, and the reset module is configured to respond to a second scan signal and transmit a reset signal to anodes of the two light-emitting devices.

12. A display panel, comprising:
a plurality of pixels, wherein the plurality of pixels comprise a first sub-pixel and a second sub-pixel adjacent to the first sub-pixel, the first sub-pixel comprises a first light-emitting device, and the second sub-pixel comprises a second light-emitting device; and
a plurality of pixel drive circuits, wherein at least one of the pixel drive circuits comprises two different types of transistors, the pixel drive circuits is configured to respond to a light-emitting control signal to simultaneously drive two adjacent sub-pixels in the same pixel or two adjacent sub-pixels in two adjacent pixels, and one of the pixel drive circuits comprises:
a first transistor configured to provide a first drive current to drive the first sub-pixel or the second sub-pixel to emit light; and
an eighth transistor configured to provide a second drive current to drive the first sub-pixel or the second sub-pixel to emit light.

13. The display panel as claimed in claim 12, wherein one of the pixel drive circuits further comprises:
a fifth transistor, wherein a gate of the fifth transistor is connected to a light-emitting control signal line, one of a source or a drain of the fifth transistor is connected to a first voltage terminal, and the other of the source or the drain of the fifth transistor is connected to one of a source or a drain of the first transistor;
a sixth transistor, wherein a gate of the sixth transistor is connected to the light-emitting control signal line, one of a source or a drain of the sixth transistor is connected to one of the source or the drain of the first transistor, the other of the source or the drain of the sixth transistor is connected to an anode of the first light-emitting device;
a twelfth transistor, wherein a gate of the twelfth transistor is connected to the light-emitting control signal line, one of a source or a drain of the twelfth transistor is connected to the first voltage terminal, and the other of the source or the drain of the twelfth transistor is connected to one of a source or a drain of the eighth transistor; and
a thirteenth transistor, wherein a gate of the thirteenth transistor is connected to the light-emitting control signal line, one of a source or a drain of the thirteenth transistor is connected to one of the source or the drain of the eighth transistor, and the other of the source or the drain of the thirteenth transistor is connected to an anode of the second light-emitting device.

14. The display panel as claimed in claim 12, wherein one of the pixel drive circuits further comprises:
a third transistor, wherein a gate of the third transistor is connected to a compensation control signal line, one of a source or a drain of the third transistor is connected to a gate of the first transistor, and the other of the source or the drain of the third transistor is connected to one of a source or a drain of the first transistor; and
a tenth transistor, wherein a gate of the tenth transistor is connected to the compensation control signal line, one of a source or a drain of the tenth transistor is connected to a gate of the eighth transistor, and the other of the source or the drain of the tenth transistor is connected to one of a source or a drain of the eighth transistor;
wherein semiconductor layers of the first transistor and the third transistor are made of different materials, and semiconductor layers of the eighth transistor and the tenth transistor are made of different materials.

15. The display panel as claimed in claim 14, wherein the first transistor and the eighth transistor comprise a silicon semiconductor layer, and the third transistor and the tenth transistor comprise an oxide semiconductor layer.

16. The display panel as claimed in claim 12, wherein one of the pixel drive circuits further comprises:
a second transistor, wherein a gate of the second transistor is connected to a first scan signal line, one of a source or a drain of the second transistor is connected to a gate of the first transistor, and the other of the source or the drain of the second transistor is connected to a reset signal line; and
a ninth transistor, wherein a gate of the ninth transistor is connected to the first scan signal line, one of a source or a drain of the ninth transistor is connected to a gate of the eighth transistor, and the other of the source or the drain of the ninth transistor is connected to the reset signal line.

17. The display panel as claimed in claim 16, wherein semiconductor layers of the first transistor and the second transistor are made of different materials, and semiconductor layers of the eighth transistor and the ninth transistor are made of different materials.

18. The display panel as claimed in claim 12, wherein one of the pixel drive circuits further comprises:
a first storage capacitor connected in series between a first voltage terminal and a gate of the first transistor;
a second storage capacitor connected in series between the first voltage terminal and a gate of the eighth transistor;
a fourth transistor, wherein a gate of the fourth transistor is connected to a data control signal line, one of a source or a drain of the fourth transistor is connected to one of a source or a drain of the first transistor, and the other of the source or the drain of the fourth transistor is connected to a data line; and
an eleventh transistor, wherein a gate of the eleventh transistor is connected to the data control signal line, one of a source or a drain of the eleventh transistor is connected to one of a source or a drain of the eighth transistor, and the other of the source or the drain of the eleventh transistor is connected to the data line;
wherein a data control signal loaded in the data control signal line comprises at least one of a scan signal and a demultiplexing signal.

19. The display panel as claimed in claim 12, wherein one of the pixel drive circuits further comprises:
a seventh transistor, wherein a gate of the seventh transistor is connected to a second scan signal line, one of a source or a drain of the seventh transistor is connected to a reset signal line, and the other of the source or the drain of the seventh transistor is connected to an anode of the first light-emitting device; and
a fourteenth transistor, wherein a gate of the fourteenth transistor is connected to a second scan signal line, one of a source or a drain of the fourteenth transistor is connected to the reset signal line, and the other of the source or the drain of the fourteenth transistor is connected to an anode of the second light-emitting device;
wherein a cathode of the first light-emitting device and a cathode of the second light-emitting device are connected to a second voltage terminal.

20. A display device, comprising a display panel, wherein the display panel comprises:
a plurality of pixel units, wherein each of the pixel units comprises a plurality of pixels; and
a plurality of pixel drive circuits, wherein at least one of the pixel drive circuits comprises two different types of transistors, and at least one of the pixel drive circuits is configured to respond to a light-emitting control signal to simultaneously drive two adjacent sub-pixels in the same pixel or two adjacent sub-pixels in two adjacent pixels.
